(19) United States
(12) Patent Application Publication
(10) Pub. No.: US 2020/0300348 A1
(43) Pub. Date: Sep. 24, 2020

(54) DIFFERENTIAL OVERMOLDED RING GEAR

(71) Applicant: METALDYNE, LLC, Plymouth, MI (US)

(72) Inventors: Carl A. KOERSCHNER, Ann Arbor, MI (US); Adam TURNER, Novi, MI (US); Hosam Z. ABDU, Livonia, MI (US); Charles V. Rupert, Rochester Hills, MI (US)

(21) Appl. No.: 16/088,098

(22) PCT Filed: Apr. 3, 2017
(86) PCT No.: PCT/US17/25691

§ 371 Date: Sep. 25, 2018

Related U.S. Application Data
(60) Provisional application No. 62/316,977, filed on Apr. 1, 2016.

(51) Int. Cl. F16H 48/40; B22D 19/00; C21D 9/32; C21D 1/18

(52) U.S. Cl. CPC F16H 48/40; B22D 19/0036; F16H 2048/385; C21D 1/18; C21D 9/32

(57) ABSTRACT

A differential assembly is disclosed herein. The differential assembly includes a ring gear and a case. The ring gear and case may comprise dissimilar materials. The ring gear may include a ferrous material and may be overmolded by the case. The case may include a non-ferrous material. Teeth may be formed in the ring gear. The teeth may be hardened through induction heating.

### FIELD OF INVENTION

The present invention relates to a differential assembly. In particular, the present invention relates to an overmolded ring gear for a differential assembly configuration suitable for a wide variety of applications including, but not limited to, a differential for an automobile.

### BACKGROUND

A differential is part of a power train of a vehicle that allows an engine to transmit torque and rotation to wheels. The differential allows an outer drive wheel to rotate at a different rate than an inner drive wheel when the vehicle turns. It includes gears or a gear train that are driven by an input shaft to drive output shafts connected to the gears.

A drive shaft connects to a pinion, and the pinion drives a ring gear of the differential. The ring gear is attached to a differential case or housing and may include teeth for driving other gears or pinions. Traditionally, bolts connect the ring gear with a differential case to prevent movement of the ring gear with respect to the differential case. In other examples, ring gears may be welded or brazed to the differential case.

Welding or brazing traditionally puts limitations on the number and type of materials that can be used. Bolts and other fasteners add weight and complexity to assembly. Further, these methods require additional parts, materials, steps, and the like.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

A differential assembly may include a ring gear and a case. The ring gear may comprise a ferrous material and the case may comprise a non-ferrous material. The ring gear may comprise curved teeth operatively engaging with pinions or gears of a drive train. The ring gear may be overmolded with the case. The non-ferrous case may reduce weight while meeting operable standards for strength and resilience.

A method of manufacturing a differential assembly may allow for coupling a case with a ring gear without the need for fasteners. The method may include forming a ring gear from a ferrous material. The ring gear may be overmolded with a non-ferrous case. Teeth may be formed in the ring gear. The teeth may be hardened via a localized heating process. The method may further include machining the case and ring gear after joining the ring gear and the case.

The following description and the drawings disclose various illustrative aspects. Some improvements and novel aspects may be expressly identified, while others may be apparent from the description and drawings.

### BRIEF DESCRIPTION OF THE DRAWINGS

The accompanying drawings illustrate various systems, apparatuses, devices and related methods, in which like reference characters refer to like parts throughout, and in which:

FIG. 1 illustrates a side view of a differential assembly comprising a ring gear joined with a case in accordance with embodiments disclosed herein;

FIG. 2 is a side, cross-sectional view of the differential assembly of FIG. 1 in accordance with embodiments disclosed herein;

FIG. 3A is a front view of a ring gear for a differential assembly comprising protrusions in accordance with embodiments disclosed herein;

FIG. 3B is a cross-sectional view of the ring gear of FIG. 3A taken along line BB in accordance with embodiments disclosed herein;

FIG. 4 illustrates a side, cross-sectional view of the ring gear of FIG. 3A taken along line AA in accordance with embodiments disclosed herein;

FIG. 5 illustrates a side, cross-sectional view of a ring gear comprising a plurality protrusion from an inner surface in accordance with embodiments disclosed herein;

FIG. 6 illustrates a side, cross-sectional view of a ring gear comprising a plurality of protrusion from an inner surface in accordance with embodiments disclosed herein;

FIG. 7 illustrates a side, cross-sectional view of a ring gear comprising a roughened inner surface in accordance with embodiments disclosed herein;

FIG. 8 illustrates a front view of a ring gear comprising a plurality protrusion extending from an inner surface in accordance with embodiments disclosed herein;

FIG. 9 illustrates a front view of a ring gear comprising a plurality apertures formed through an inner surface of the ring in accordance with embodiments disclosed herein;

FIG. 10 illustrates a front view of a ring gear comprising a plurality circular apertures formed through an inner surface of the ring in accordance with embodiments disclosed herein;

FIG. 11 illustrates a front view of a ring gear comprising a plurality grooves formed through an inner surface of the ring in accordance with embodiments disclosed herein;

FIG. 12 is a front view of the differential assembly of FIG. 1 in accordance with embodiments disclosed herein;

FIG. 13 is a front, cross-sectional view of the differential assembly of FIG. 1 in accordance with embodiments disclosed herein; and

FIG. 14 illustrates an exemplary method of manufacturing a differential in accordance with embodiments disclosed herein.

### DETAILED DESCRIPTION

Reference will now be made to exemplary embodiments, examples of which are illustrated in the accompanying drawings. It is to be understood that other embodiments may be utilized, and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” mean an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

While embodiments and examples describe a differential for a vehicle, it is noted that the systems, apparatuses, and methods described herein may be applied to a variety of applications, including automobiles, aircrafts, personal transport systems (e.g., motorized scooters), or the like. As such, references to a vehicle are used as exemplary embodiments for purposes of explanation and clarity. It is noted that the present teachings may not be limited to such examples.

A differential generally includes a housing or case, and a number of gears, pinions, and the like. The gears and pinions may be referred to as a gear set. This gear set may allow for operation of wheels of a vehicle at different speeds. For example, when a vehicle turns, a first or inner wheel (e.g., the wheel at the inner curve of the turn) may be driven at a lower speed than a second or outer wheel. This may result in increased control of the vehicle in comparison to vehicles that do not include a differential.

In some systems, such as automotive systems, the components of the differential may be subject to forces that require the components to have a certain or defined strength. For instance, automobiles (e.g., cars, trucks, farm equipment, etc.) may require components to be formed of ferrous materials (e.g., iron, cast iron, steel, etc.). In some applications, one or more components of the differential may not need to have the strength of such ferrous materials. One such application, may allow a differential housing to be made of a lighter weight material such as aluminum, magnesium, copper, lead, nickel, tin, titanium, zinc, alloys, or the like. Such materials may not have the same strength as ferrous materials, but may be lighter weight, cheaper, and/or more than sufficient for certain applications.

As an example, as consumers become more conscious of fuel saving automobiles, vehicle weight becomes more important. Moreover, lighter weight vehicles may place a reduced amount of stress on a differential in comparison with heavier, traditional vehicles. For these and other reasons, components of a differential may be made of lighter weight materials than conventionally called for. In another aspect, disclosed apparatuses and methods may reduce production steps, costs, and/or reduce the number of components of the differential.

In at least one embodiment, a differential case may comprise a castable metal that is cast within and/or about a portion of a ring gear. The ring gear may comprise steel or another ferrous metal having a desired strength for driving pinions and/or wheel axles. The ring gear may be formed as a substantially circular ring, having an internal or inner surface. The ring gear may be placed in a mold. Material may be deposited into the mold to form the case so that the case directly contacts the internal surface of the ring gear. This may bond or join the ring gear directly with the case. It is noted that the ring gear may or may not have teeth formed thereon during the casting process. For instance, if the teeth are formed prior to casting, care should be taken so that the teeth are not damaged or deformed during the casting process. In other examples, the teeth may be formed after casting. When formed after casting, the teeth may be subsequently hardened, such as through an induction hardening process.

In an induction hardening process, the teeth may be selectively heated by induction heating and then quenched. The quenched teeth undergo a martensitic transformation that may harden the teeth. It is noted that other areas or components of the differential (e.g., the case) may be generally not affected by the induction heating. In an example, a method may include placing teeth comprising conductive material into a sufficiently strong alternating magnetic field. Current may flow through the material to create heat. It is noted that the depth of the hardening process may be controlled by properties associated with the induction, such as the frequency of the alternating field, the surface power density, the permeability of the material, the heat time and the diameter of the material, or material thickness. In another aspect, quenching the heated teeth may include applying water, oil, or a polymer based quench to alter the teeth and form a martensitic structure.

It is noted that the teeth may be formed prior to casting and may be protected by a protective member or otherwise protected. For instance, a shield member may mate with the teeth of the ring gear to protect the teeth during casting. In another example, casting may be accomplished without placing pressure on the teeth, or otherwise exposing the teeth to harmful contact with casting equipment or other potentially damaging materials.

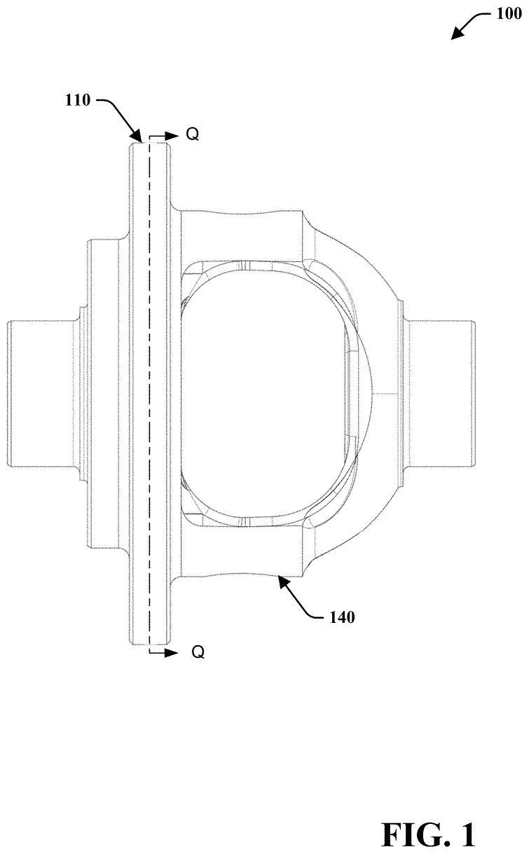

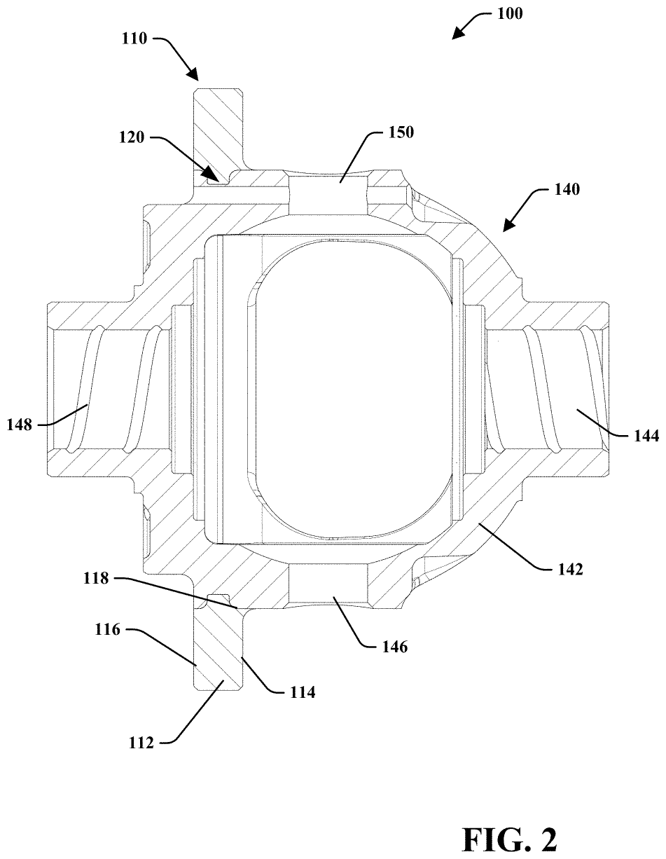

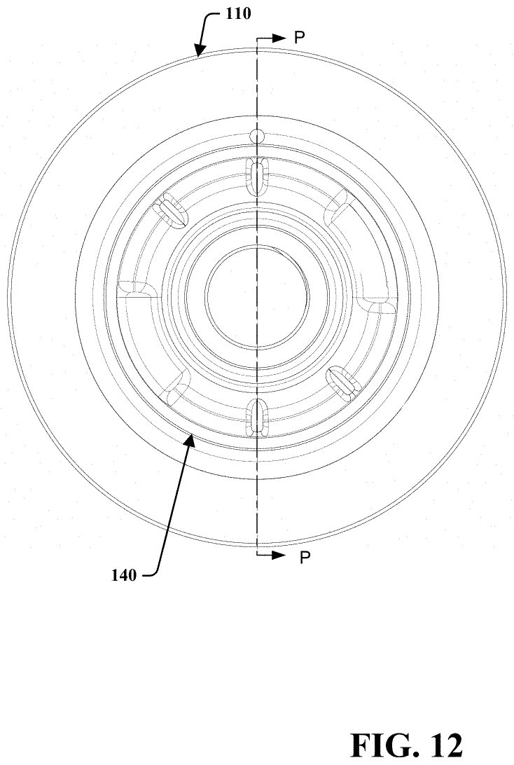

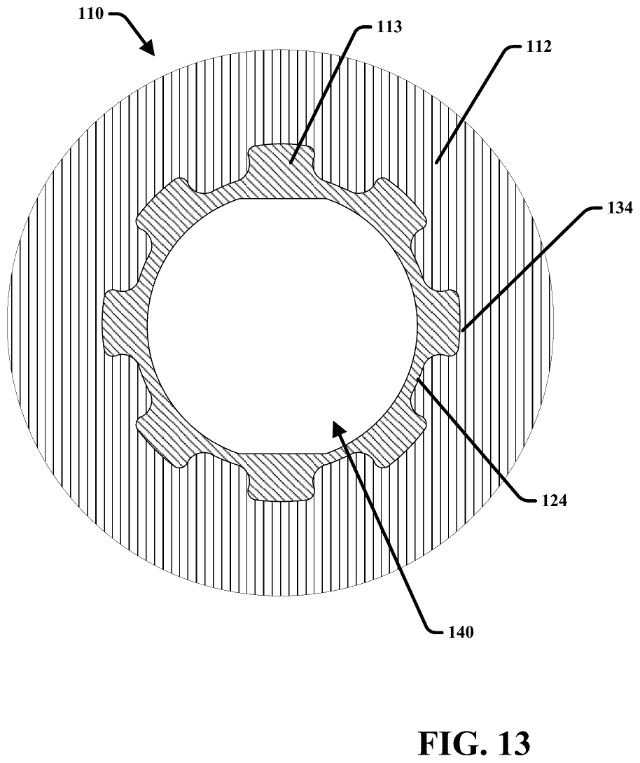

Turning now to the figures, FIGS. 1, 2, and 12-13 illustrate an exemplary ring gear 110 and case 140 of a differential apparatus 100. FIG. 1 is a side view of the differential apparatus 100 with line QQ, and FIG. 13 is a cross-sectional view taken along line QQ. FIG. 12 is a front view of the differential apparatus 100 showing line PP, and FIG. 2 is a cross-sectional view taken along line PP. It is noted that the differential apparatus 100 may include various other components and/or dimensions in accordance with various disclosed aspects. In an example, the differential apparatus 100 may be utilized in a vehicle as described herein.

According to embodiments, the ring gear 110 and the case 140 may comprise disparate materials that may comprise different properties. For instance, the ring gear 110 may comprise ferrous materials and the case 140 may comprise non-ferrous materials. The non-ferrous material may allow for reduced weight in comparison with a ferrous case. It is noted that the non-ferrous case 140 may be removably or irremovably attached to the ferrous ring gear 110. For instance, the non-ferrous case may be attached via one or more fasteners, a press-fit, friction-fit or self-broaching process, and/or over-molding or casting process. In an exemplary embodiment, the ring gear 110 may be at least partially formed and then may be placed into a mold or die-cast. The case 140 may then be molded or cast into the mold, such that the case 140 is overmolded with the ring gear 110. This may reduce assembling cost, weight, required components (e.g., fasteners), increase efficiency of assembly processors, or the like.

It is noted that the casting process may account for the differences in the properties of the ferrous and non-ferrous materials. Such properties may include the coefficient of thermal expansion for the different materials. For instance, the non-ferrous case 140 and the ferrous ring gear 110 may have coefficient of thermal expansion mismatch. The non-ferrous case 140 and the ring gear 110 may be subject to a relatively broad range of temperatures due to the typical uses of automobiles in cold and hot environments. The mismatch may mean that the fractional change in size per degree change in temperature between the ring gear 110 and non-ferrous case 140 differ. It is noted that alloys may be selected that match more closely such that the ferrous and non-ferrous materials have a lesser difference in the coefficient of thermal expansion mismatch.

In an example, the case 140 may comprise aluminum or an aluminum alloy. Aluminum has a relatively high coefficient of thermal expansion relative to other metals, such as steel. Thus, a ring gear 110 comprising steel and a case 140 comprising aluminum may have a large mismatch. This mismatch may lead to bending, stress, and/or fracture of joint 120. Embodiments described herein may reduce or alleviate bending, stress, or fracturing. For instance, joint 120 may comprise one or more coatings or layers of materials disposed between the case 140 and the ring gear 110. The coating may include a material selected to alleviate thermal stress at one or more ranges of temperatures. This may be achieved by gradually transitioning mismatch from steel to aluminum (or from other ferrous materials to non-ferrous materials) through layers of intermediate materials. In another example, the casting and/or joining process may be selected based on the type of materials utilized for one or more of the case 140 and/or gear 110. For instance, magnesium and steel may be joined utilizing a hot chamber process, and where the case 140 is aluminum or an aluminum alloy, a cold chamber process.

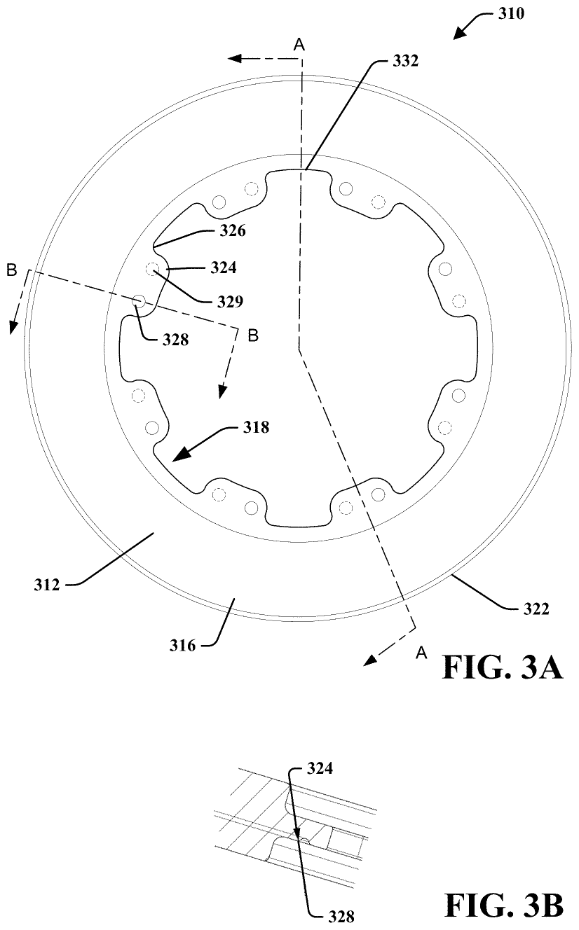

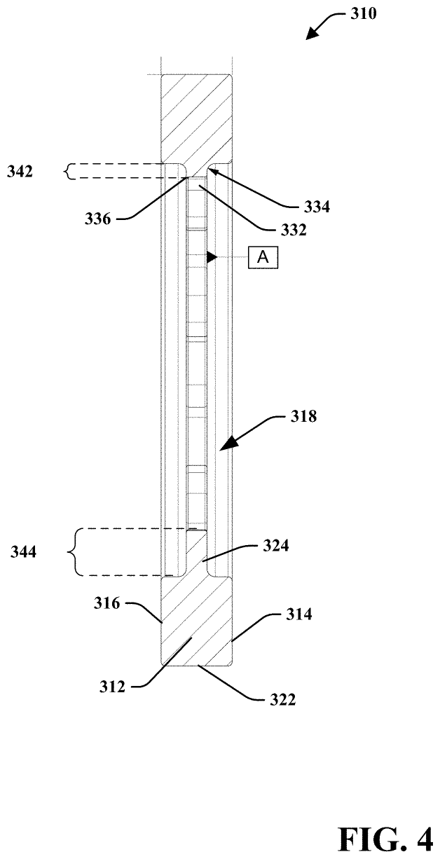

Turning to FIGS. 3A-4, ring gear 310 is depicted. FIG. 4 depicts a cross-section of ring gear 110 along line AA. Ring gear 310 may comprise an inner surface comprising geometric formations that may alter properties, e.g., increased strength, decreased breakage, etc., of a joint with a case, such as joint 120 of FIG. 1. It is noted that ring gear 310 may comprise similar aspects as ring gear 110.

Ring gear 310 may comprise a body 312 that may comprise a non-ferrous material. The body 312 may include a first side 314, a second side 316, an inner surface 318 and an outer surface 322. The first side 314 may generally face towards a main body of a case, such as similarly shown in FIG. 1—first side 114 of ring gear 110 faces towards a main body 142 of case 140. Likewise, the second side 316 may be generally opposed to the first side 314. The inner surface 318 may operatively abut a case, such as similarly shown in FIG. 1—inner surface 118 abuts case 140. In an aspect, the inner surface 318 may comprise or may form a portion of a joint (e.g., joint 120) when attached to a case.

Inner surface 318 may further include one or more protrusions or nodes 324 that may form a geometric feature. Each node 324 may allow molten material of a case to interlock and permanently affix the ring gear 310 to the case. The node 324 may provide increased surface area, an anchor, or the like for a joint between the ring gear 310 and a differential case. In another aspect, the nodes 324 may prevent or reduce slippage between ring gear 310 and a case (e.g., case 140) when assembled. It is noted that ring gears comprising various other geometric features are considered in the scope and spirit of this disclosure. Such features may include protrusions, cavities, channels, roughened or scored surfaces, and the like.

It is noted that ring gear 310 may comprise i nodes, where i is a number. In FIG. 3A, ring gear 310 comprises eight nodes. Nodes 324 may be separated by ridges 332. Each node may comprise similar dimensions and may be spaced evenly about the inner surface 318. Nodes 324 may comprise rounded corners 326. Rounded corners 326 may reduce stress on portions of the ring gear 310 or a case in comparison with squared corners. In some embodiments, ring gear 310 may comprise nodes having different shapes, non-evenly spaced nodes, nodes with squared corners, or the like.

Each node 324 may comprise formations on its surface. For instance, node 324 may comprise one or more reliefs 328 and 329. As shown, relief 328 may face towards second side 216, and relief 329 may face towards first side 314. The reliefs 328 and 329 may comprise areas relieved of material (e.g., dimples, groves, etc.). This may alter the bonding of ring gear 310 with a case. For instance, during casting of a case, material may flow into the reliefs 328 and 329. This may create a more efficient bond between the ring gear 310 and a case (e.g., case 140). FIG. 3B shows a cross-sectional view of ring gear 310 taken at line BB. It is noted that reliefs 328 and 329 may comprise other shapes, such as grooves that extend across the nodes 324.

FIG. 4 illustrates a cross-sectional view of ring gear 310 taken at line AA. Ridge 332 may extend a first distance 342 from inner surface 318 and node 344 may extend a second distance 344 from inner surface 318. In an aspect, first distance 342 may be generally less than second distance 344. While each node 324 are illustrated as extending generally the same distance from inner surface 318, it is noted that nodes may extend at different distance relative each other. Similarly, while each ridge 332 are illustrated as extending generally the same distance from inner surface 318, it is noted that ridges may extend at different distance relative each other. Moreover, while corners 334 and 336 are shown as generally rounded, it is noted that corners 334 and 336 may be tapered, squared, or the like.

Turning back now to FIGS. 1 and 2, ring gear 110 may be formed or pre-manufactured without teeth. This may prevent damage to teeth during casting of the case 140. Thus, after the case 140 is cast and joined to the ring gear 110, the teeth (not shown) may be formed in the body 120 of ring gear 110. For example, the teeth may comprise curved grooves formed in body 120 and proximal first side 114. These teeth may interact with pinions or gears that may drive an axle of a vehicle.

In at least one embodiment, the teeth may be hardened after they are formed or machined. In an aspect, the ferrous ring gear 110 and the non-ferrous case 140 may be subjected to coefficient of thermal expansion mismatch. Because of this mismatch, some hardening techniques would weaken and/or damage joint 120. As such, localized hardening techniques may be utilized to harden the teeth. For instance, induction hardening may target the teeth with localized heat treatment. This will localize the heat or hardening process such that the case 140 and/or joint 120 maintain their integrated and desired properties.

It is noted that the case 140 and ring gear 110 may be further machined after being joined. For instance, case 140 may include one or more apertures 144, 146, 148, and 150. The apertures or features of the apertures may be machined after a casting process. It is further noted that the case 140 may be machined with various other geometric features.

The various described embodiments may allow for a reduction in assembly cost, reduction in weight, ability to utilize different materials (e.g., light-weight materials, heavier/stronger materials, etc.), reduced production steps, or the like. It is further noted that while embodiments describe a non-ferrous case, any desired castable material may be utilized. Such castable materials may include, for example, aluminum, magnesium, iron, alloys, or the like. In at least one example, the material is a non-ferrous material. In another aspect, ring gears may comprise non-ferrous materials, ferrous materials coated with non-ferrous materials, or the like. In another aspect, a non-ferrous case 140 may be press-fit with a ring gear comprising a splined inner surface in a self-breaching process.

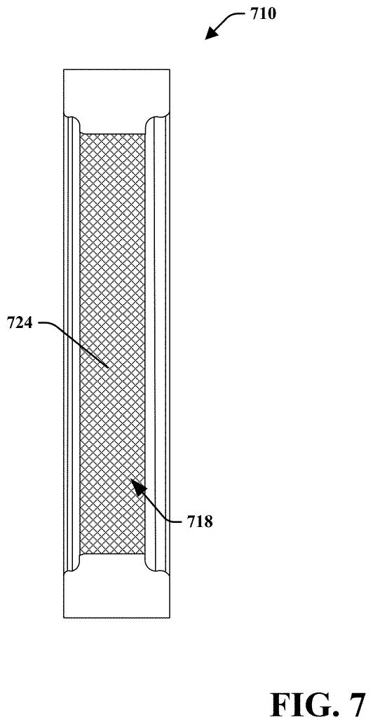

In view of the subject matter described herein, methods that may be related to various embodiments may be better appreciated with reference to the flowchart of FIG. 7. While the method is shown and described as a series of blocks, it is noted that associated methods or processes are not limited by the order of the blocks. It is further noted that some blocks and corresponding actions may occur in different orders or concurrently with other blocks. Moreover, different blocks or actions may be utilized to implement the methods described hereinafter. Various actions may be completed by one or more of users, mechanical machines, automated assembly machines (e.g., including one or more processors or computing devices), or the like.

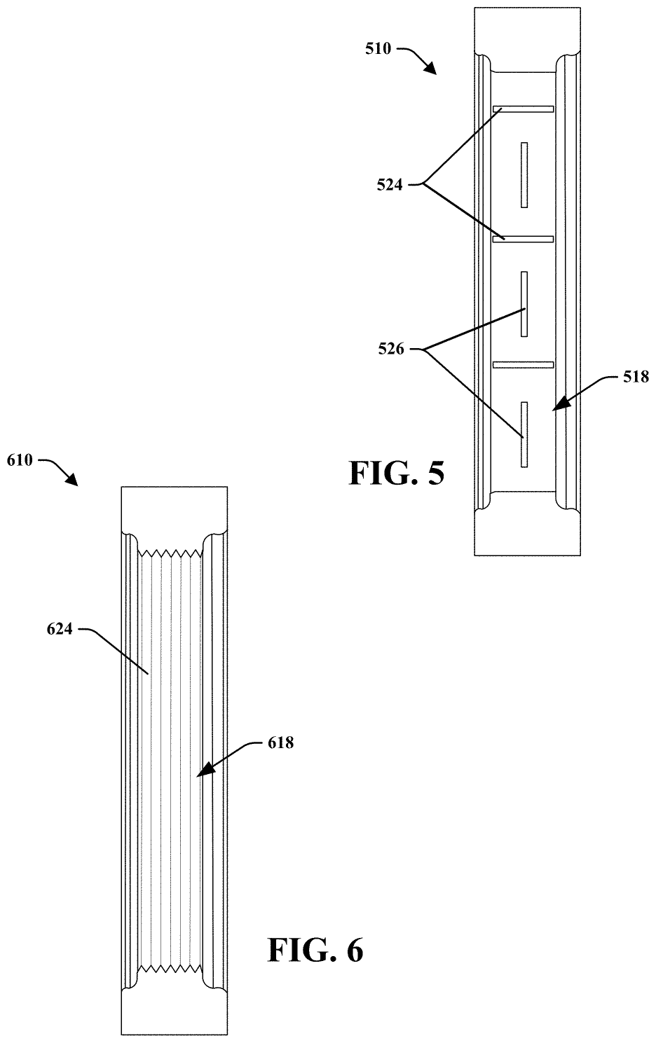

Turning to FIGS. 5-7, with reference to FIGS. 1-2, there are ring gears 510, 610, and 710, respectively. It is noted that each of the ring gears 110, 310, 510, 610, and 710 may comprise similar aspects or features, unless context suggests otherwise. For example, each of the above referenced ring gears may comprise a ferrous material and may be configured to be received by a die-cast. A non-ferrous case (e.g., case 140) may then be attached to each of the ring gears as described herein. The ring gears 110, 310, 510, 610, and 710 are provided to illustrate exemplary inner surfaces with geometric features.

For instance, FIG. 5 illustrates ring gear 510 comprising a plurality of protrusions extending from inner surface 518. The protrusions may include one or more vertical protrusions 526 and one or more horizontal protrusions 524. The differently oriented protrusions may provide for altered (e.g., increased) strength of a joint for forces acting in different directions.

As another example, FIG. 6 illustrates ring gear 610 comprising an inner surface 618 that may include a plurality of protrusions, such as ridges or ribs 624. The ribs 624 may receive molten material of a case during a casting process. The material may cool and/or harden within the ribs 624 to form a joint.

FIG. 7 illustrates an exemplary embodiment of ring gear 710 having an inner surface 718 that may include roughened surface 724. While inner surface 718 is shown as substantially covered by roughened surface 724, it is noted that the inner surface 718 may include surface areas that are generally smooth and areas that are roughened to make a mosaic-like surface.

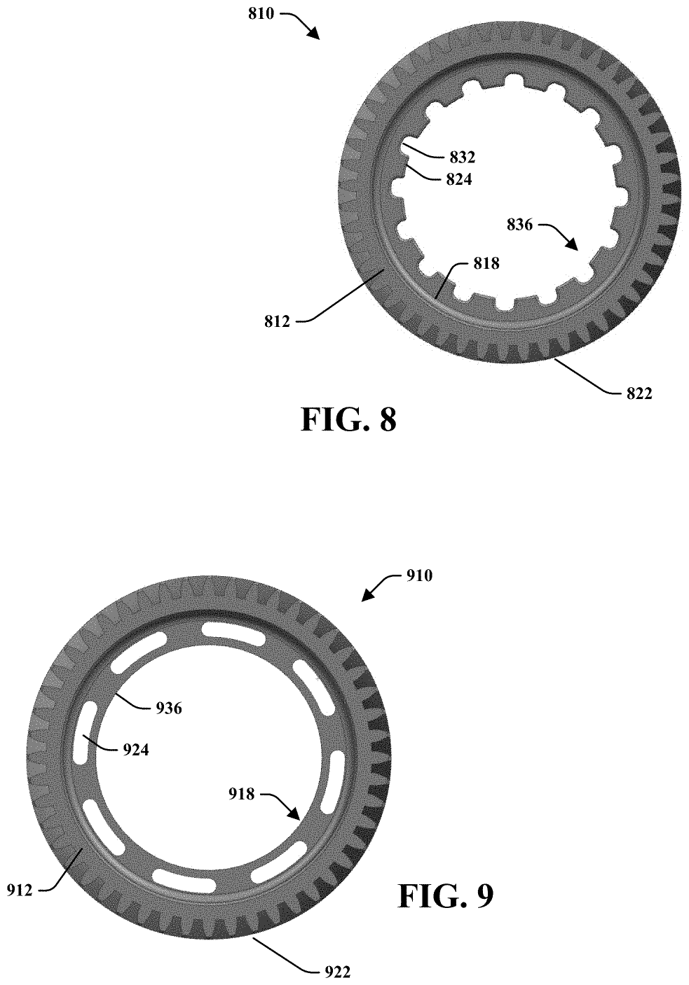

Turning to FIGS. 8-11, with reference to FIGS. 1-2, there are ring gears 810, 910, 1010, and 1110, respectively. It is noted that each of the ring gears 110, 310, 510, 610, 710, 810, 910, 1010, and 1110 may comprise similar aspects or features, unless context suggests otherwise. For example, each of the above referenced ring gears may comprise a ferrous material and may be configured to be received by a die-cast. A non-ferrous case (e.g., case 140) may then be attached to each of the ring gears as described herein. Ring gears 810, 910, 1010, and 1110 provide exemplary

FIG. 8 illustrates ring gear 810 comprising a plurality of protrusions or nodes 824 extending from an inner ring 836 disposed proximal inner surface 818. The nodes 824 may be separated by cutouts 832. When a case is casted, it may fill the cutouts 832 and interlock with nodes 824.

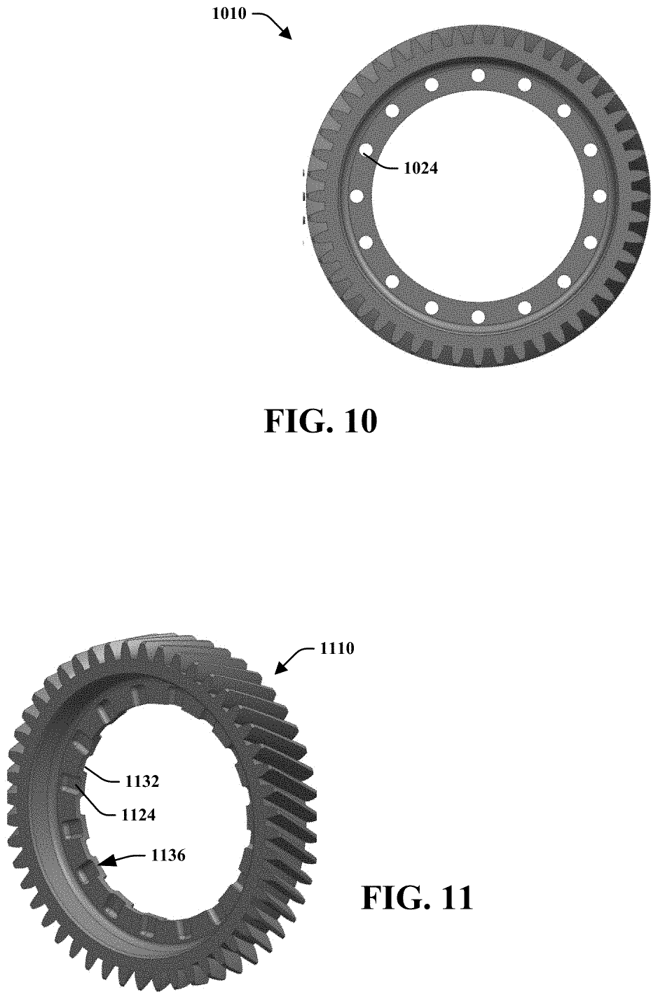

FIG. 9 illustrates ring gear 910 comprising a plurality of cutouts 924 disposed within an inner ring 936. The inner ring may extend from inner surface 918 of the ring gear 910. When a case is casted, it may fill the cutouts 924 to interlock with the ring gear 910. The cutouts 924 may comprise any desired shape, such as polygonal, rectangular, elliptical, irregular in shape, or the like. For instance, FIG. 10 illustrates a ring gear 1010 comprising a plurality of generally circular cutouts 1024.

FIG. 11 illustrates ring gear 1110 that may comprise depressions 1124 and 1132 formed in an inner ring 1136. In an aspect, the depressions 1124 and 1132 may alternate sides of the inner ring 1136. The depressions 1124 and 1132 may comprise any desired shape, such as polygonal, rectangular, elliptical, irregular in shape, or the like. When material is cast around the depressions 1124 and 1132 the material may fill the depressions 1124 and 1132. This may allow a case to be cast into the ring gear 1110 and lockable secure thereto.

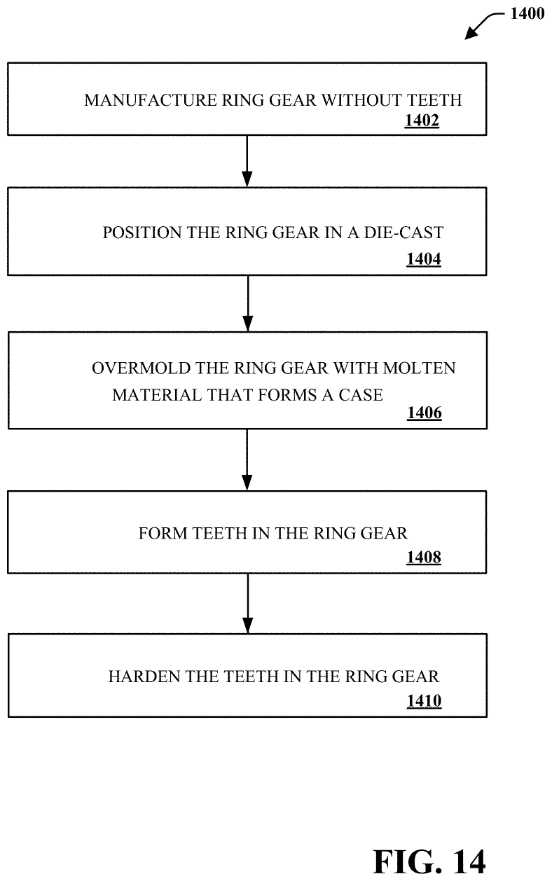

In view of the subject matter described herein, a method that may be related to various embodiments may be better appreciated with reference to the flowchart of FIG. 14. While method 1400 is shown and described as a series of blocks, it is noted that associated methods or processes are not limited by the order of the blocks. It is further noted that some blocks and corresponding actions may occur in different orders or concurrently with other blocks. Moreover, different blocks or actions may be utilized to implement the methods described hereinafter. Various actions may be completed by one or more of users, mechanical machines, automated assembly machines (e.g., including one or more processors or computing devices), or the like.

FIG. 14 is a flow chart of an exemplary method 1400 of manufacturing a differential as described herein. The method 1400 may be utilized to form a differential having a light-weight case and a heavier-weight or stronger ring gear. For example, the differential may comprise a ferrous ring gear and a non-ferrous case.

At 1402, a manufacturer may manufacture a ring gear (e.g., ring gear 140, 340, etc.) that does not comprise teeth. This ring gear may comprise a ferrous material that may or may not be subject to a hardening process. In an aspect, the ring gear may be pre-manufactured then provided to another party that may cast materials.

At 1404, the ring gear may be positioned in a die-cast, such as a die-cast for a differential case. It is noted that positioning the ring gear may include other or additional steps, such as coating the die-cast, coating the ring gear, or the like.

At 1406, the ring gear may be overmolded with molten material that will form a case of a differential. As described herein, the molten material may include non-ferrous material (e.g., aluminum, magnesium, and/or alloys thereof). It is noted that the molten material may be cooled, quenched, or otherwise allowed to cool.

In an example, as shown in FIG. 13, material 113 forming at least a portion of the case 140 may be deposited within a mold that has ring gear 110 positioned therein. The body 112 of the ring gear 110 may include nodes 124 and ridges 134. As material 113 is cast, it may fill space around the nodes 124 and ridges 134.

At 1408, teeth may be formed in the ring gear. The teeth may comprise curved teeth appropriately shaped to drive pinions or gears of a differential system. In an aspect, the teeth may be machined into a portion of the ring gear by a precision machining system.

At 1410, the teeth may be hardened so that they resist damage during operation. Hardening may include a localized hardening process, such as induction hardening. For example, inductive current may be directed in or through the teeth. This may heat the teeth without directly heating and/or substantially heating the case.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define embodiments disclosed herein. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A differential assembly comprising:
a ring gear comprising:
a main body comprising a ferrous material; and
one or more protrusions extending from an inner surface of the ring gear towards a general center of the ring gear; and
a case attached to the ring gear and comprising a non-ferrous material, wherein at least a portion of the case contacts the protrusions operatively securing the case to the ring gear.

2. The differential assembly of claim 1, wherein the ferrous material comprises steel.

3. The differential assembly of claim 1, wherein the non-ferrous material comprises at least one of aluminum, magnesium, an aluminum alloy, or a magnesium alloy.

4. The differential assembly of claim 1, wherein the ring gear and case are attached without any fasteners.

5. The differential assembly of claim 1, wherein the ring gear comprises one or more reliefs operatively formed on the one or more protrusions.

6. The differential assembly of claim 1, wherein the one or more protrusions comprise rounded edges.

7. The differential assembly of claim 1, wherein a coefficient of thermal expansion of the ferrous material is different from a coefficient of thermal expansion of the non-ferrous material.

8. A ring gear for a differential assembly comprising:
a main body comprising an outer surface and an inner surface, wherein the inner surface comprises one or more geometric formations disposed proximal a center of the ring gear, wherein the one or more geometric formations operatively secure the ring gear with a case of the differential assembly.

9. The ring gear of claim 8, wherein the one or more geometric formations comprise at least one protrusion extending from the main body towards the center.

10. The ring gear of claim 9, wherein the at least one protrusion comprises a first relief on a first side of the at least one protrusion.

11. The ring gear of claim 10, wherein the at least one protrusion further comprises a second relief on a second side of the at least one protrusion.

12. The ring gear of claim 8, wherein the one or more geometric formations comprise at least one aperture or at least one depression.

13. The ring gear of claim 8, wherein the ring gear comprises at least one of aluminum, magnesium, copper, lead, nickel, tin, titanium, zinc, or an alloy thereof.

14. A method of forming a differential assembly, the method comprising:
providing a ferrous ring gear; and
overmolding the ferrous ring gear with a non-ferrous case.

15. The method of claim 14, further comprising:
forming teeth in the ferrous ring gear after the overmolding.

16. The method of claim 15, further comprising:
hardening the teeth through a targeted heating process.

17. The method of claim 16, wherein the targeted heating process comprises induction hardening.

18. The method of claim 14, further comprising providing the ferrous ring gear within a mold.

19. The method of claim 14, further comprising forming one or more protrusions in an inner surface of the ferrous ring gear, the one or more protrusions extending towards a center of the ferrous ring gear.

20. The method of claim 14, further comprising machining the overmolded case to form one or more apertures sized and shaped to receive a shaft.
